(19) United States
(12) Patent Application Publication
(10) Pub. No.: US 2019/0085625 A1
(43) Pub. Date: Mar. 21, 2019

(54) ROLLER BLIND END BRACKET WITH RETAINING MEMBER

(71) Applicant: ZMC Metal Coating Inc., Woodbridge (CA)

(72) Inventor: Philip Ng, Thornhill (CA)

(73) Assignee: ZMC Metal Coating Inc., Woodbridge (CA)

(21) Appl. No.: 16/059,200

(22) Filed: Aug. 9, 2018

Related U.S. Application Data
(60) Provisional application No. 62/560,226, filed on Sep. 19, 2017.

(51) Int. Cl. E06B 9/44; E06B 9/78

(52) U.S. Cl. CPC E06B 9/44; E06B 2009/785; E06B 9/78

(57) ABSTRACT

An end bracket for a roller blind, the end bracket including a bracket member adapted for mounting to a surface, the bracket member having an interior face and a roller tube mounting portion for supporting an end of a roller tube of the roller blind. The end bracket also including one or more flexibly resilient retaining members mounted to the bracket member, the one or more retaining members bearing against, and applying a biasing force to, the end of the roller tube when the end is supported by the bracket member, thereby hindering relative movement between the end of the roller tube and the bracket member when the end is supported by the bracket member. This helps to prevent an unintentional disengagement of the end of the roller tube from the bracket member.

### CROSS REFERENCE TO RELATED APPLICATIONS

This patent application claims the benefit of and priority on U.S. Provisional Patent Application No. 62/560,226 having a filing date of 19 Sep. 2018.

### BACKGROUND OF THE INVENTION

### Technical Field

This invention relates generally to roller blinds or shades, and in particular to an end bracket for a roller blind.

### Prior Art

Roller blinds are a popular method to limit the intrusion of light through a window or other opening. Roller blinds can also be useful when positioned about a window for thermal and sound insulating purposes.

Roller blinds are typically comprised of a fabric or similar material wound about a roller tube. The roller tube is suspended between two end brackets which are mounted on or about a window frame. Commonly, one of the end brackets houses or has otherwise associated with it the blind's primary drive mechanism (which may include a return spring, clutch, etc.). The other or opposite end bracket typically has associated with it an idle end which serves to support the opposite end of the roller tube.

During operation, the roller tube may at times be subjected to jostling or other forces. For example, in some instances when the blind's clutch mechanism is engaged to wind or unwind the blind material about the roller tube, if the clutch is activated too quickly or too forcefully, the excessive force may cause an end of the roller tube to “jump” relative to the end brackets. Such jumping posses a potential safety hazard since such movement may result in one or both ends of the roller tube becoming disengaged from the end brackets and falling, causing damage or injury.

### BRIEF SUMMARY OF THE INVENTION

The invention provides an end bracket for a roller blind, the end bracket including a bracket member adapted for mounting to a surface, said bracket member having an interior face and a roller tube mounting portion for supporting an end of a roller tube of the roller blind; and one or more flexibly resilient retaining members mounted to said bracket member, said one or more retaining members bearing against, and applying a biasing force to, said end of said roller tube when said end is supported by said bracket member, thereby hindering relative movement between said end of said roller tube and said bracket member when said end is supported by said bracket member and helping to prevent an unintentional disengagement of said end of said roller tube from said bracket member.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper side perspective view of a typical roller blind employing an end bracket in accordance with an embodiment of the invention.

FIG. 2 is a partially exploded view of the roller blind shown in FIG. 1, with the end bracket detached from its roller tube end.

FIG. 3 is a front perspective view of the end bracket of FIG. 2.

FIG. 4 is a side perspective view of the roller blind of FIG. 1 with the roller tube partially installed.

FIG. 5 is a cross-sectional view of FIG. 4 along line A-A.

FIG. 6 is a side perspective view of the roller blind of FIG. 1 with the roller tube fully installed.

FIG. 7 is a cross-sectional view of FIG. 6 along line B-B.

### DETAILED DESCRIPTION OF PREFERRED EMBODIMENTS

The present invention may be embodied in a number of different forms. The specification and drawings that follow describe and disclose some of the specific forms of the invention.

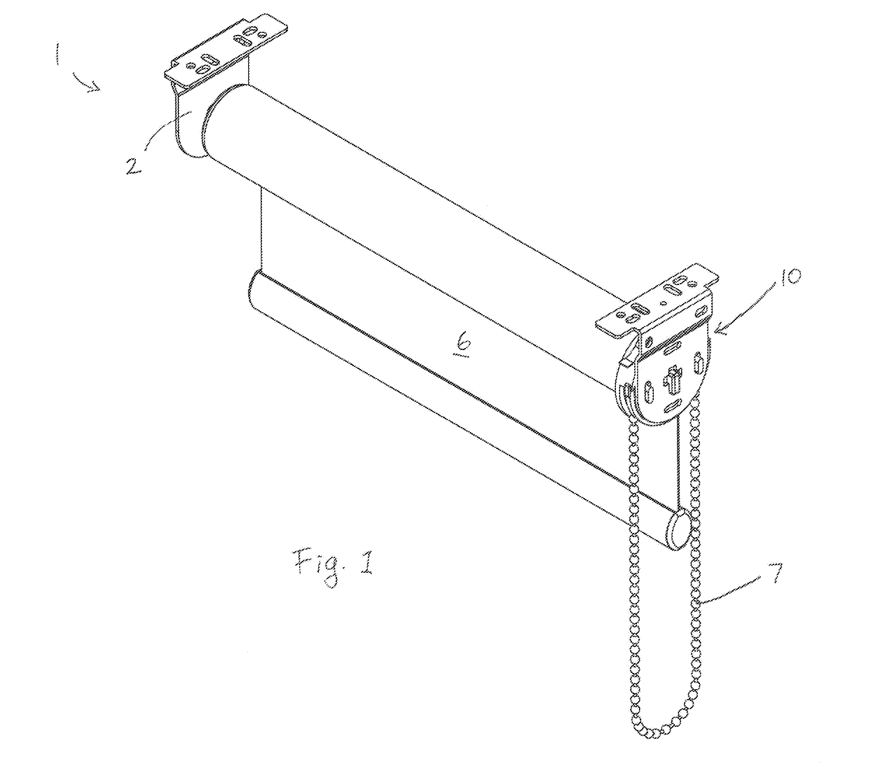

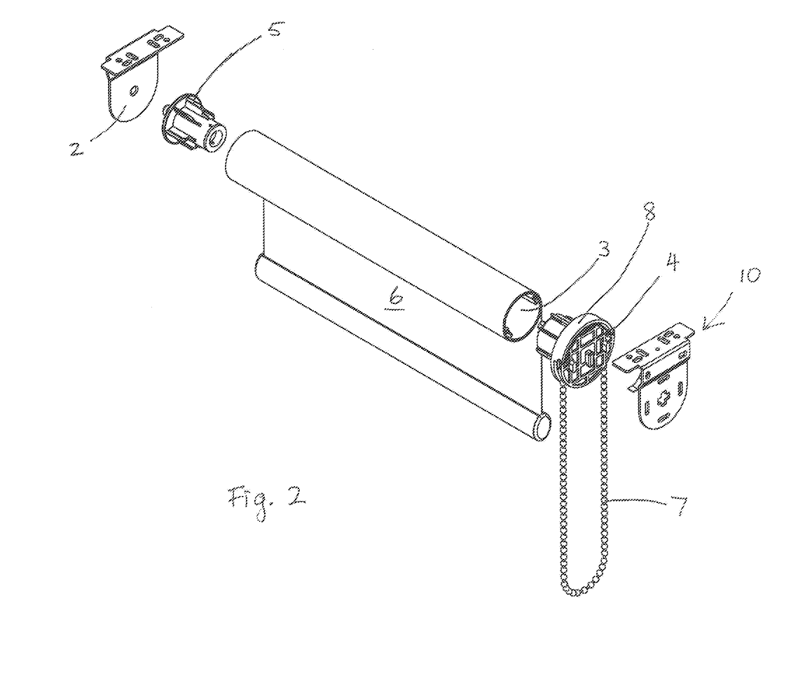

FIGS. 1 and 2 show a relatively standard roller blind 1 that is mounted to a surface through the use of end brackets, referred to herein as a clutch end bracket 10 and an idle end bracket 2. Each end bracket is releasably secured to an end of a roller tube 3. In the present embodiment, one end of roller tube 3 is associated with a clutch 4, and the other opposite end of roller tube 3 is associated with an idle end 5.

Blind fabric 6 is received about roller tube 3 and is wound or unwound from the roller tube through the operation of the clutch which is activated by a chain or cord 7. As depicted, clutch 4 includes a housing 8 that is secured to one end of roller tube 3. Idle end 5 is releasably secured to one end of the roller tube, and generally serves to hang or secure the end of the roller tube, opposite the clutch, to its corresponding idle end bracket 2. Clutch end bracket 10 serves the purpose of supporting the clutch end of roller tube 3.

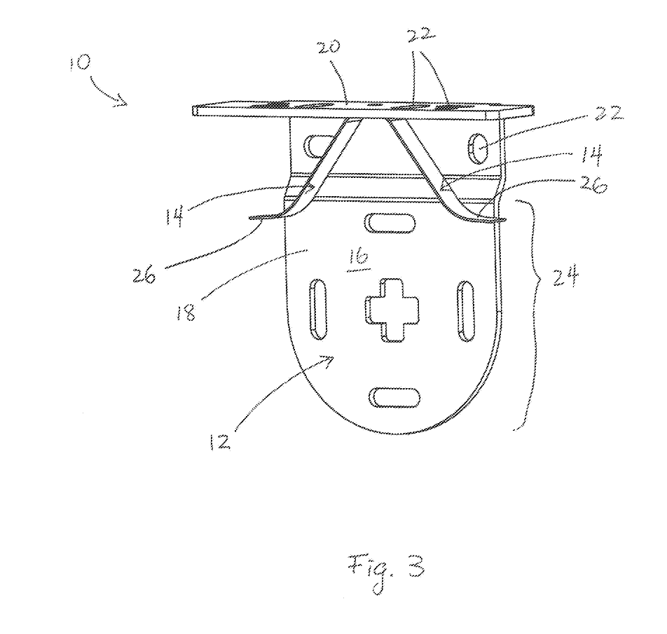

With reference to FIG. 3, clutch end bracket 10 includes a bracket member 12 and one or more flexibly resilient retaining members 14 mounted to bracket member 12. Bracket member 12 is adapted for mounting to a surface, such as a wall or window frame (not shown), and has an interior face 16. In the particular embodiment depicted, bracket member 12 includes a bracket plate 18 and a mounting flange 20 extending generally perpendicularly from the bracket plate from interior face 16. As shown, mounting flange 20 and bracket plate 18 have apertures 22 for receiving fasteners therethrough for mounting bracket member 12 to a surface or window frame.

Bracket plate 18 further includes a roller tube mounting portion 24 for releasably receiving and supporting an end of roller tube 3, in this case the clutch end. In the particular embodiment depicted in FIG. 3, roller tube mounting portion 24 includes cross-shaped and obround shaped apertures which receive hooks upon the back of housing 9 of clutch housing 8. It will be readily understood by a skilled person that roller tube mounting portion 24 may include different structural configurations for releasably receiving and supporting clutch 4.

As noted above, clutch end bracket 10 also includes one or more flexibly resilient retaining members 14 mounted upon bracket member 12. In the present embodiment, retaining members 14 extend from mounting flange 20 and are configured to bear against the clutch end of roller tube 3 when the end of the roller tube is received and supported by clutch end bracket 10. In this manner, retaining members 14 apply a biasing force to the clutch end and help to hinder relative movement between the clutch end and clutch end bracket 10. This helps to prevent unintentional disengagement of clutch housing 8 from clutch end bracket 10.

In the depicted embodiment, the one or more retaining members 14 form an inverted V-shaped configuration. While FIG. 3 shows a pair of retaining members 14 extending from mounting flange 20 and forming the inverted V-shaped configuration, it would be understood that retaining member 14 may instead be a single member which forms the inverted V-shaped configuration.

In one embodiment of the invention, retaining members 14 are in the form of a pair of legs that depend downwardly from flange 20 and are spaced apart in order to receive, therebetween, a portion of clutch 4. Retaining members 14 may also include outwardly flared lower ends 26. Flared lower ends 26 may assist in directing clutch 4 into the area defined by the inverted V-shaped configuration. The legs forming retaining members 14 may be joined at the apex of the inverted V-shaped configuration, or may be separate and may have upper ends separately secured to flange 20.

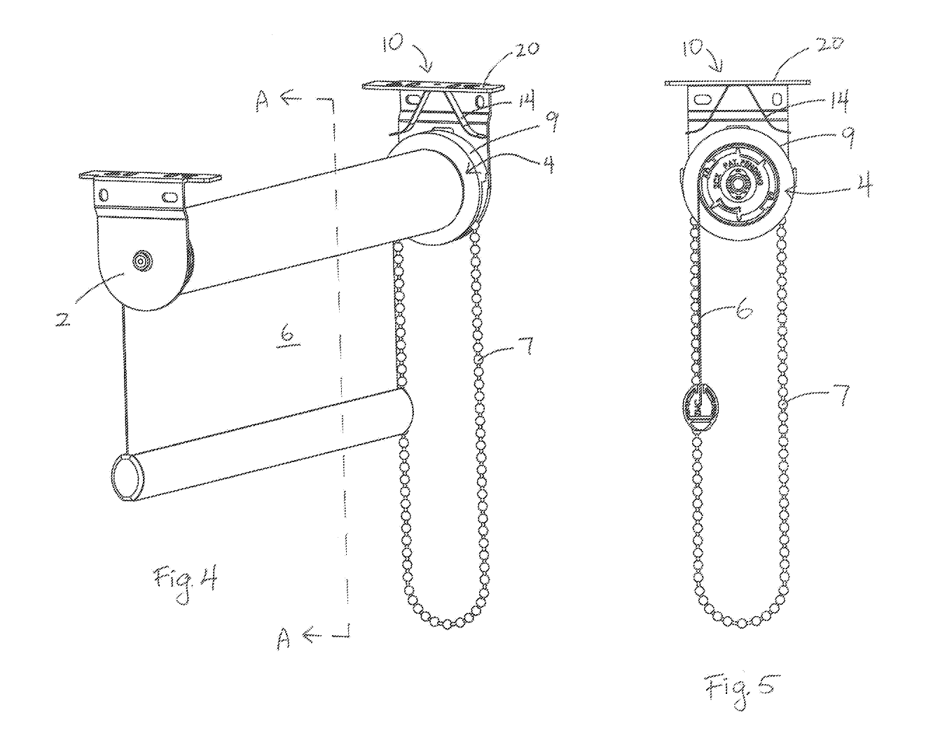

FIGS. 4 and 5 show clutch end bracket 10 prior to full installation of roller blind 1. Typically, after idle end bracket 2 and clutch end bracket 10 are mounted to a surface or window frame (not shown), idle end 5 is coupled to idle end bracket 2. As this point, the clutch end is spaced apart from retaining members 14.

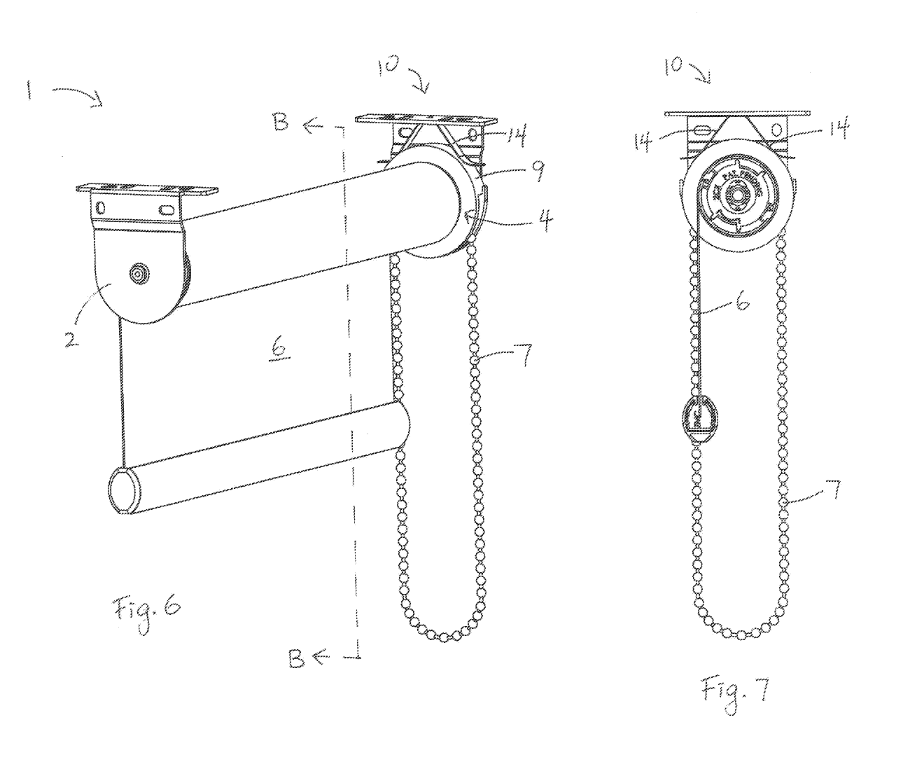

As shown in FIGS. 6 and 7, the clutch end is then coupled to clutch end bracket 10 by lifting the clutch end towards mounting flange 20 to allow hooks on the back of housing 8 to be inserted through the apertures in clutch end bracket 10 and secured thereto. The flexible resilience of retaining members 14 causes retaining members 14 to bend outwardly and to bear against housing 8. When the clutch end is lowered into place and hooked to clutch end bracket 10, retaining members 14 continue to bear against housing 8. The force exerted on clutch housing 8 by retaining members 14 encourages the clutch end to remain in place. This helps to prevent “jumping” or other movement of the clutch end relative to clutch bracket member 10 and hinders unintentional disengagement of the hooks on clutch housing 8 from clutch end bracket 10.

While the retaining members are described and shown to be in an inverted V-shaped configuration, other shaped configurations are possible, including an arcuate or a rectangular configuration.

As well, while the retaining members are described and shown to be attached to a clutch end bracket, a skilled person will readily understand that in alternate embodiments, idle end brackets may also include retaining members for bearing against their corresponding idle ends in a similar manner as described above. Retaining members secured to such idle end brackets would hinder relative movement between the idle end and the idle end bracket when the idle end is engaged with the idle end bracket, thereby also preventing unintentional disengagement of the idle end from the idle end bracket.

The scope of the claims should not be limited by the preferred embodiments set forth in the examples, but should be given the broadest interpretation consistent with the description as a whole.

What is claimed is:

1. An end bracket for a roller blind, the end bracket comprising:
a bracket member adapted for mounting to a surface, said bracket member having an interior face and a roller tube mounting portion for supporting an end of a roller tube of the roller blind; and
one or more flexibly resilient retaining members mounted to said bracket member, said one or more retaining members bearing against, and applying a biasing force to, said end of said roller tube when said end is supported by said bracket member, thereby hindering relative movement between said end of said roller tube and said bracket member when said end is supported by said bracket member and helping to prevent an unintentional disengagement of said end of said roller tube from said bracket member.

2. The end bracket as claimed in claim 1, wherein said bracket member comprises a bracket plate and a mounting flange extending generally perpendicularly from said bracket plate, proximate said interior face, said one or more retaining members mounted to said mounting flange.

3. The end bracket as claimed in claim 2, where said one or more retaining members comprise a pair of downwardly depending legs in generally V-shaped configuration, each of said legs bearing against a portion of said end of said roller blind when said end is supported by said bracket member.

4. The end bracket as claimed in claim 3, wherein said end of said roller tube includes a clutch and said legs are spaced apart to receive and bear against portions of an exterior surface of a housing of said clutch.

5. The end bracket as claimed in claim 1, wherein said legs have outwardly flared lower ends to assist in directing said end of said roller tube into the said V-shaped area defined by said legs when said end of said roller tube is supported on said mounting portion.

6. The end bracket as claimed in claim 5, wherein said legs form a unitary V-shaped configuration mounted to said mounting flange.

7. The end bracket as claimed in claim 5, wherein said legs have upper ends that are mounted to said mounting flange.
